(19) United States
(12) Patent Application Publication
(10) Pub. No.: US 2010/0233670 A1
(43) Pub. Date: Sep. 16, 2010

(54) Frozen Viable Solid Organs and Method for Freezing Same

(76) Inventor: Zohar Gavish, Beit Elazary (IL)

Correspondence Address: THE NATH LAW GROUP, 112 South West Street, Alexandria, VA, 22314, US

(21) Appl. No.: 12/223,867

(22) PCT Filed: Feb. 13, 2006
(86) PCT No.: PCT/IL2006/000180

§ 371 Date: Dec. 29, 2008

(51) Int. Cl. A01N 1/02

(52) U.S. Cl. 435/1.3

(57) ABSTRACT

Disclosed is a method of freezing bulky biological material, comprising transferring heat out of said material to cool the material and increasing the rate of heat transfer during a time period when the inner portion of said biological material freezes and releases latent heat. This method allows prolonged ex-vivo preservation of solid mammalian organs, including a liver or significant portion thereof and a heart. The invention also provides a bank of deposited body organs or tissues as well as methods for operating such a bank.

### FIELD OF THE INVENTION

This invention relates to the cryogenic preservation of biological material such as solid organs of non-hibernating mammals, including human organs. More specifically, the present invention discloses methods for freezing biological material and also discloses preserved viable solid organs of non-hibernating mammals, and uses thereof.

### LIST OF REFERENCES

The following references are brought to facilitate description of the background of the present invention, and should not be construed as limiting the patentability of the invention:
Belzer F O, Lancet, 1967. 2: p. 536-38
Collins G M, et al., Lancet, 1969. 2: p. 1219-22
Fahy G M, et al, Cryobiology. 2004 April; 48(2):157-78
Gosden R G et. al., Hum Reprod. 2003 June; 18(6):1165-72
Greater Houston Liver Transplant Partnership website: www.ghltp.org, Jul. 3, 2003
Nutt M P, et al., Transplant Proc, 1991. 23: p. 2445-6.
Pienaar B H, et al., Transplantation, 1990. 49: p. 258-60
Qayumi A K, et al., J Heart Lung Transplant, 1991. 10: p. 518-26.
Rubinsky, B., et al., Biochem Biophys Res Commun, 1994. 200(2): p. 732-41
Smith A U, Proc. R. Soc. Lond. B. Biol. Sci. 1957 Dec. 17; 147(929):533-44.
Wicomb W, et al., J Thorac Cardiovasc Surg 1982 83: p. 133-40.
U.S. Pat. No. 4,117,881 to Williams et al.
U.S. Pat. No. 5,873,254 to Arav
   U.S. Pat. No. 6,187,529, to Fahy, et al.
U.S. Pat. No. 6,740,484, to Khirabadi, et al.
U.S. Pat. No. 6,916,602, to Arav
WO 03/056919 to Arav, et al.
PCT IL 2005/000876 to Shaham, et al

### BACKGROUND OF THE INVENTION

Donated organs such as liver, heart and others that are harvested from brain-dead donors (or in some cases live donors) must be transplanted within a very short time, depending on the limited storage period for each organ, even when stored at hypothermic temperatures (e.g. 4-8° C.). Heart, for example, must be transplanted within 2-4 hours; liver has a longer storage term of 12 to 24 hours etc.

To date, livers, kidneys and hearts have been preserved ex-vivo in hypothermic conditions (without freezing). Hypothermia does not stop metabolism but it slows biochemical reaction rates and decreases the rate at which intracellular enzymes degrade essential cellular components necessary for organ viability. Hypothermic storage of livers, kidneys, and hearts is done in one of two mariners: continuous perfusion and cold storage Continuous perfusion storage involves the continuous infusion of a cold preservation fluid through the vasculature of the harvested organ (Wicomb et al, 1982). In cold storage; the organ is normally suffused with a preservation solution before, or immediately after, being excised, and then placed in a cold chamber (ca. 4-8° C.), without further manipulation until its preparation for use.

Using continuous perfusion, canine kidneys were hypothermically preserved for 72 h (Belzer et al, 1967) and rat livers were preserved at a temperature of −3° C., for a period of 6 h (Rubinsky, 1994). The best results to date in liver preservation by continuous machine perfusion were obtained with canine livers that were preserved for 72 h at 5° C. (Pienaar, et al, 1990).

Introduction of Collins solution and successful preservation with simple cold storage (Collins, et al., 1969) enabled present day use of cold storage. In these hypothermic conditions the liver remains viable for a shorter period of time, and thus ischemic storage of donated livers is normally limited to 12-24 h (Greater Houston Liver Transplant Partnership, 2003).

Experimental studies for preserving hearts have demonstrated the superiority of continuous perfusion over cold ischemic storage (Qayumi et al, 1991 and Nutt et al, 1991). However, the logistic difficulties associated with continuous perfusion systems, including their high cost, limits the use of this method (for hearts, livers and other organs).

A major goal in the field of organ transplantation is to extend the preservation period of organs while maintaining their functionality and viability at a level that will allow transplantation. One option that was therefore suggested is storage at subzero conditions, either by freezing or vitrification. In vitrification, a vitrification solution is added to the biological material, such that the freezing point of the sample is reduced, which in turn leads to vitrification rather than freezing (i.e. ice is essentially not formed). This method suffers from several disadvantages, including (a) that the vitrification solution contains high concentrations of cryoprotectants (ca. 50% v/v), which are toxic; and (b) that fractures are caused to the vitrified organ by the vitrification procedure.

One of the problems associated with freezing biological material, the alternative sub-zero storage, is the release of latent heat during the crystallization stage of the process. The reaction of water molecules breaking and rejoining to form an ice crystal releases a large amount of energy in the form of heat (latent heat) causing a rise in the temperature of the surroundings. The heat in this case will be transferred mainly to a conductive material, meaning to the ice crystals that were just formed, giving rise to transient thawing followed by recrystallization, a sequence that may damage the cells. Recrystallization in itself is a damaging process. Additionally, the results of this recrystallization are that, as cooling continues, the cells may be exposed to sub-physiological temperature for an extended period (isotherm), which may cause chilling injury. In addition, this may lead to intracellular ice crystallization, which may cause further damage.

The current method to overcome the problem of damage to cells due to release of latent heat is by removing the excessive heat by adjusting the cooling rate at specific time points and ensuring rapid freezing by maintaining a high ratio of surface to volume. In other words, the sample to be frozen is made to be as thin as possible, and thereby heat from the inner part of the sample, which is being released through the surface of the sample, will be removed faster due to the steep temperature gradient. In this way it is possible to apply the optimal cooling rates for each sample and at the same time provide a heat sink for rapid absorption of the released latent heat.

An example for this method is described in U.S. Pat. No. 4,117,881 (Williams et al.), wherein blood cells (or similar biological tissue) are frozen in a thin bag (0.1-1 cm wide), sandwiched between two heating plates and cooled using a cooling fluid. A thermocouple is used and upon detection of the release of latent heat, the heating plates are shut off, to further increase the rate of removal of heat from the cells.

However, this method is not applicable to large volume samples, especially where the geometric shape of the sample is fixed, such as with whole organs or tissue, with a low surface to volume ratio that does not allow efficient removal of the latent heat from the sample. First, there is the difficulty of generating heat transfer within the large thermal mass, and the almost unavoidable temperature gradient resulting in the large mass causes temperature detection from outside the mass (like in the case of U.S. Pat. No. 4,117,881) to be practically useless. In addition, the packing density of cells within an organ and the presence of many different cell types, each with its own requirements for optimal cryopreservation conditions, limit the recovery of the cells when a single thermal protocol is imposed on all of them.

When freezing large volume samples with relatively low ratio of surface to volume, the release of latent heat may cause a long isothermal period (or even heating) in the material being frozen. At the same time, the temperature of the cooling means or the surrounding medium is lowered, thus increasing the temperature difference between the sample and its surroundings. Consequently, when latent heat is no longer released, the temperature of the material being frozen will drop too rapidly to a temperature close to the temperature of the surrounding environment. This might cause a cooling rate, which is higher than optimal and thus possibly damaging due to intracellular crystallization. Optimal predetermined cooling rate is typically at a level that allows water to leave the cell and freeze outside it, while the cell is shrinking. Because of the higher cooling rate, water within the cell will not have enough time to leave it before freezing and therefore the water will freeze within the cell causing intracellular ice formation, which may damage the cell.

Freezing and thawing rates have a direct effect on the survival rates. On one hand, cooling rates should be slow enough to allow dehydration and avoid intracellular ice formation, but on the other hand should be fast enough to avoid recrystallization due to the release of latent heat. One solution for freezing biological material having a large volume is disclosed in WO 03/056919, wherein biological samples are frozen via an isothermal stage, while at least one cross section of the material becomes uniform during freezing. This method was applied for example to semen that was frozen directionally It should be noted however that basically, an isothermal stage is expected to slow down the latent heat removal. One option of performing the method of WO 03/056919 is by directional freezing. In directional freezing a temperature pattern (or gradient) is established in the object being frozen and the cold front propagates within the object in accordance therewith, resulting in improved chances of survival. A device and method for directional freezing were reported for example in U.S. Pat. No. 5,873,254.

In nature, some animals (including some mammals) undergo a state of regulated hypothermia (hibernation), during which the animals slow their metabolism to a very low level, with lowered body temperature. In some cases, hibernating animals are known to freeze, and later thaw while remaining viable. Accordingly it is commonly accepted that biological material (e.g. solid organs) taken from hibernating animals may survive freezing. Indeed, Smith (1957) reported the freezing of ex-vivo hearts of hibernating animals. Nonetheless, to date freezing of solid organs of non-hibernating mammals was reported only in respect to rat ovaries (Gosden 2003) and sheep ovaries (U.S. Pat. No. 6,916,602).

### SUMMARY OF THE INVENTION

The following are some terms that will be used herein and their meaning in the content of the invention:

“Biological material” means anything comprising biologically derived material such as cells and/or biological liquids (e.g. plasma) or biological molecules or structures or tissue, for example material comprising solid organs and/or deformable biological material.

“Bulky biological material” means biological material having, while being frozen, at least a portion having a minimal dimension along any cross section of at least 1.6 centimeters, 2.5 centimeters or even 5 centimeters. In case of deformable biological material this means that during the temperature change the material is in a container or device that constrains the material to have such minimal dimension.

“Deformable biological material” biological cells or clusters of cells or tissue which are amenable to change of shape without significant damage to the function or structure of the biological material. Such deformable biological material may be material comprising blood cells (e.g. whole blood or a fraction thereof, a sample of red blood cells, platelets, white blood cells and/or mononuclear cells) or any other cells or small cellular structures (e.g. embryos or embryonic cells, sperm cells, ova, pancreatic cells, Langerhans islets, skin samples, cartilage containing samples etc.) It is noted that in the present invention, the deformable biological material may contain portions of biological material that is non-deformable, such as bone fractions in a cartilage sample, etc.

“A solid organ” means any differentiated structural and functional biological tissue that is specialized for some particular function (e.g. respiration) and that may be resected and potentially used for transplantation. Such solid organ has three-dimensional structural constraints, which limit its amenability to change of shape; damaging the three-dimensional shape of such “solid organ” leads to significant damage to its function. A solid organ may be a whole organ, such as a liver, heart, kidney, intestine, ovary, lung, spleen, or pancreas. Alternatively a solid organ may be a “significant portion” of a whole organ, being a portion capable of performing the basic functions of the whole organ. For example, the liver consists of two main lobes (left and right), and two smaller lobes, the caudate lobe and the quadrate lobe. A significant portion of a liver may be any one lobe or part of a lobe that can be transplanted and still provide sufficient functionality of a liver, but in the case of a heart, for example, the minimal part may be the whole heart and not only part of it.

“A non-hibernating mammal” means any mammal that is not capable of hibernation, namely not capable of undergoing a stage of reduced body (and organ) temperature and metabolism in order to survive a period of cold weather. For example, a non-hibernating mammal may be a human being.

The “inner portion” of a biological material means a portion of the material that is situated in the material's interior and is distant from the periphery of the material by at least 5%, at times 10%, 20% or even 30% of the distance between the periphery and an opposite side of the biological material. For example, in case of a piece of tissue or organ that has a thickness of 5 cm, the inner portion will consist of the portions distanced from external walls of the tissue or organ by at least 2.5 mm, at times at least 5 mm, 10 mm or even 15 mm from the side of the tissue portion or organ. As will be explained further below, in accordance with an embodiment of the invention a temperature probe, typically a thermocouple, may be inserted for temperature measurement, such insertion being typically by a blood vessel or by other means so as not to cause any significant damage to the structure or function of the biological material.

“Viable” means that the biological material (e.g. organ) comprises some viable cells that are metabolically active or would become metabolically active after their release from the preservation state. Preferably in a viable organ at least 10% of the cells are viable cells, or preferably at least 30% or even 50% and more preferably above 75%. Viability may be assessed according to any applicable method known in the art for any given solid organ and/or its cells, including one or more of the assays mentioned or used herein (e.g. the live/dead ratio assay). The release from the preservation state may be through any protocol that should be chosen to suit the method of preservation and the nature of the organ, including raising the temperature of the biological material in accordance with the method of the present invention. In the alternative, a viable organ or tissue means that upon release from the preservation state the preserved biological material restores its normal function. For example, where a said biological material is liver or a significant portion of a liver (e.g. a lobe), this means that normal liver function can be restored in transplantation in a recipient; where said biological material is, for example, a heart, this means that it may resume normal haemodynamic properties upon thawing.

The term “freezing” means reduction of the temperature of biological material (or a portion thereof which is being frozen), such that ice crystals are formed within the material. Freezing includes reduction of the average temperature of the biological material to or past the temperature in which the crystallization process is completed. This temperature depends on the composition of the material being frozen. Typically, the freezing process is considered to lower the temperature to or below about −5° C. or less, or at least −8° C. or less, typically at least −10° C., preferably at least −20° C. or even −40° C., at times at least −80° C. and occasionally even to or less than −196° C.

The term “cryoprotectant agent” or “CPA” means any agent that is added to a biological material or to a solution in which the biological material is cryopreserved to improve the post thaw viability of the biological material. Of specific interest are “Intracellular CPAs” that may penetrate the cell membranes and are thought to replace water inside the cells, thus preventing crystallization therein, to enlarge the un-frozen fraction of the frozen solution, to buffer osmolarity and/or to stabilize the membrane and prevent mechanical damage caused by ice crystals. Examples of CPAs are dimethyl sulfoxide (DMSO) and polyalcohols (e.g. glycerol, ethylene glycol, propylene glycol), and other molecules including butandiol and methanol. Extracellular CPAs include sucrose, dextrose, trehalose, and proteins, carbohydrates such as hydroxy ethyl starch (TES), dextran, etc.

The term “Static Freezing System (SFS)” refers an embodiment of the static directional freezing or thawing apparatus as described in PCT/IL2005/000876, the content of which is incorporated herein in its entirety by way of reference. Disclosed in that PCT application is a method and apparatus for changing the temperature of a biological material from a first temperature to a second temperature within a time period, one of the said first or second temperature being above freezing temperature and the other being below freezing temperature. The biological material is placed in tight contact with at least one, preferably between two heat exchangers, and the temperature controlled in at least one of the heat exchangers such that a freezing temperature front propagates in said material away from at least one of the two heat exchangers. This method may allow directional freezing by generation of one or more controlled thermal gradients within the object, without a need to move the object being frozen or warmed.

The material to be frozen may be contained in a container, for example a bag made of flexible or pliable material or a container made of a hard material such as glass or metal, which is held in direct or in abutting contact with the heat exchanger or with a temperature-control block, that conducts heat to or from the object to be frozen, with the heat exchanger forming part of said block. In the following examples, specific embodiments of this device were used. In the embodiments used herein, the device includes two heat exchangers, each being a thermally conductive block having cooling means (liquid nitrogen channels within the blocks) and electrical heating modules, allowing accurate control of the block temperature as well as imposition of a fast change thereof. The two blocks are displaceable to yield a better contact between them and the biological material and to ensure relatively tight fitting of the biological material into the space formed between them. The “Large Static Freezing System (LSFS)” is an SFS that can handle containers having sides that are in contact with the heat exchanger or block of up to 20×30 cm. The volume of such container can be as high as 600 cc, or even much higher if depth (the distance between the blocks) is increased. The “Small Static Freezing System (SSFS)” refers to an SFS where the blocks are adapted to handling small volume samples (e.g. 0.5-2.5 ml, or 0.5-2.5 cm²).

The term “Multi-Thermal Gradient (MTG)” refers to a freezing apparatus based on the disclosure of U.S. Pat. No. 5,873,254 that is adapted for the dimension of the bulky biological material of the present invention. This apparatus may apply different temperature gradients to yield different cooling rates resulting in precise and uniform cooling rates at a variety of rates, for example at a rate of 0.1° C./min across the sample being frozen. The device enables directional freezing and thus control of propagation of the ice forming front through the sample. Examples of such an apparatus device are MTG 615 (IMT Ltd. Israel), and any adaptation thereof for use with bulky biological material.

To date, for reasons some of which were noted above, freezing biological material from its exterior, while maintaining its viability, was limited to only small samples with relatively high surface to volume ratio (such as disclosed in U.S. Pat. No. 4,117,881), or to samples that do not comprise a solid organ (such as disclosed in WO 03/056919). Contrary to common belief, it was now discovered in accordance with the invention that such a cooling mode (namely cooling biological material by heat removal from the material's surrounding) can also be effectively used for cryopreservation of bulky biological material, without undue damage, whereby the viability of the material is maintained. This is achieved in accordance with the invention by increasing the cooling rate of the material at a time period where a latent heat is released. This results, as aforesaid, in minimal damage and accordingly with minimal loss in viability of the biological material.

Accordingly the present invention provides, by a first aspect, a method of freezing bulky biological material, the method comprising transferring heat out of said material to cool the material and increasing the rate of heat transfer during a time period when the inner portion of said biological material freezes and releases latent heat.

Transferring heat may be achieved by any method known in the art, including use of a commercially available controlled rate freezer such as a Planar freezer (Planer, UK), or an equiaxial freezer, etc. However, the preferred method of freezing is directional freezing, namely a freezing process wherein a cold front propagates through the bulky biological material in one direction, or in two opposite directions. Examples of freezing apparatuses that allow such freezing include the Static Freezing System (SFS), and the directional freezing apparatuses described in U.S. Pat. No. 5,873,254 (each adapted for freezing bulky biological material).

The rate of heat transfer out of the biological material may be controlled for example by changing the temperature of the medium or objects that surround the biological material. This may include reducing a temperature of a gaseous or liquid medium surrounding the biological material (as in a Planar freezer apparatus, for example) or changing the temperature of a conductive block (as in SFS) so as to increase the temperature difference between the material and surrounding, or by increasing the rate of change in the temperature of the surround material (e.g. imposing a desired gradient along a block in a directional freezing device or changing the velocity of movement of bulky biological material along this device).

The rate of heat transfer before the step, which the rate is increased to counter the effect of release of the latent heat, may be the same or may be different than the rate of heat transfer after said step.

The period of time in which the heat transfer is increased to counter the affect of the latent heat may be determined on an empirical basis and are set accordingly. The setting may depend on the type of material, its dimensions, prior treatment, etc., as known per se.

In the alternative, the time period in which the inner portion of said biological material freezes and releases latent heat may be determined, during the freezing process, through temperature sensors embedded or inserted into the biological material. Typically, such temperature sensors are part of a feedback loop that controls the rate of heat transfer from the biological material. The control mechanism of the heat transfer may include, in addition to the temperature sensor in the inner portion of said biological material, also temperature sensors that sense a temperature at a biological material's periphery, as well as that of the heat exchanger or the cooling block. The temperature sensor that is inserted in the inner portion of the bulky biological material is typically a thermocouple device. In case the biological material is an organ, such as thermocouple may be introduced into the organ's interior through one of the organ's blood vessels, or other natural apertures.

In a typical cooling process of the present invention, the temperature or a rate of change of temperature, is monitored and any deviation from a desired temperature or desired rate of temperature or change (i.e. that the measured temperature is too high or that the cooling rate is too low), the rate of heat transfer is increased. The rate of heat transfer may be increased for example by increasing the temperature differential between the heat exchanger or cooling block and the periphery of the biological material or by increasing the rate of heat removal in said heat exchanger or block. In a directional freezing device this rate may also be changed by increasing the velocity of the biological material along a temperature gradient, or by using a different temperature gradient, or both. The increase in rate by some embodiments may be manual, e.g. done by an operator monitoring the temperature change of the organ's inner portion, or, by other embodiments may be automatic using a computerized control system.

Preferably, the method of the present invention is carried out on the bulky biological material (especially a solid organ) as soon as possible after being harvested from the donor's body, and before significant damage is caused due to ex vivo processes. Nonetheless the method may also be performed after a period of storage of the biological material by various storage protocols, such as cooling and storing for a time period at 4-8° C.

The increase in the rate of heat transfer during a time period when the inner portion of said biological material freezes and releases latent heat will typically result in that the heating of biological material at that period of time is lower and/or of shorter duration in comparison to that which would otherwise occur. More preferably, the increase in rate of heat transfer is such so that heating is avoided entirely.

As known in the art, the rate of cooling of biological material is determined according to various factors (e.g. the type of biological material, its size, and composition, rate of freezing of the intra-cellular fluid and the extra-cellular fluid, which affects the rate of water molecules exit from the cells to the extra-cellular fluid, etc.). The cooling rate should preferably be adjusted to a preferred rate in which there will be a gradual crystallization process with minimal damage. An exemplary preferred cooling rate is about 0.1-0.5° C./min. The rates of heat transfer before and after the step of increasing of the rate the heat transfer are each influenced by tissue specific factors; and the increase in the rate of heat transfer is preferably limited to a minimal period of time, so that the deviation from the otherwise preferred rate, is minimal

In addition, it is noted that the temperature measurement during freezing in one or more portions of the biological material may also be important for record keeping or for any additional purposes, such as to quality control of the freezing process. Such records may be used to assess the viability of the biological material (e.g. an organ for transplantation) especially in cases where a tissue sample cannot be removed from the organ for a viability assay prior to transplantation.

The freezing of biological material may be continued after the step of increasing the rate of heat transfer is concluded, to a final temperature of the frozen biological material that may be −5° C. or less, −8° C. or less, −10° C. or less, −20° C. or less, −80° C. or less, or even −196° C. The eventual storage of the frozen biological material may be in a temperature of −80° C. or less, e.g. in liquid nitrogen or liquid nitrogen vapor.

Thawing of the biological material may be done in any manner known in the art that causes little or no damage to viability, structure, and/or function of the biological material. Examples for such thawing methods include one or more of (a) thawing by transferring the material to room temperature, (b) submerging it in a warmed bath, (c) removing the material from a receptacle in which it was frozen and submerging it directly in a container with a solution of a desired temperature (e.g. a solution that is warmed by being placed in a warm water bath), (d) using any warming device known in the art such as tube warming blocks, dish warming blocks, thermostat regulated water baths etc. or using directional warming as described in PCT IL 2005/00876 (e.g. using an SFS).

This invention is a breakthrough of successfully freezing. For the first time, organs such as hearts and liver of non-hibernating mammals may be frozen, while maintaining the organ functionality and viability at a level which may allow them to be transplanted in an organ recipient.

Accordingly, in an embodiment of the method of the present invention the biological material may include a solid organ, such as a heart or a liver or a significant portion of a liver, such as a whole lobe.

The present invention further provides any solid organs frozen by the method of the invention. Likewise, the present invention further provides a viable organ, thawed after freezing by the method of the present invention.

While occasionally cryoprotectants may be used, it is generally preferred, in accordance with the invention, that the level of cryoprotectants will be kept to a minimum. Moreover, cryoprotectants may not be needed in accordance with the invention to the same extent as they were needed in prior art methods. It is thus preferred that cryoprotectants will comprise less than 25% weight per volume (w/vol, gr/100 ml), more preferably less than 20% w/vol, typically less than 15% w/vol, desirably less than 10% w/vol and at times even less than 5% w/vol of cryoprotectants. Particularly, with respect to the cryoprotectants dimethyl sulfoxide (DMSO) and glycerol, it is preferred that their level will be less than 5% and most preferably that they will not be included at all.

By freezing solid organs (even from a non-hibernating mammal) in accordance with the present invention, the ex vivo storage period of an organ to be transplanted, may be considerably increased over prior art methods, while maintaining the organs suitable viable for subsequent transplantation. This of course requires, and as will be appreciated by the artisan, proper storage conditions, e.g. storage at a low temperature of less than −80° C. in liquid nitrogen or in an environment of liquid nitrogen vapor. Organs may be stored, without significant loss in their viability, for a period longer than is known in the art, such as (e.g. at least 3 days, typically 7 days, 12 days or even 21 days, or at times even for a longer period of time). In the case of hearts, the ability to store them without significant loss in their viability even for only 5 hours or longer, or even 12 hours or longer, at times 24 hours or longer, is in itself a breakthrough in heart preservation technology. The organs may be heart, liver, or a lobe of a liver. Organs frozen in accordance with the invention and stored for such a period of time, are another aspect of the invention.

Among the benefits of this extension of the preservation period of organs, while maintaining their functionality and viability at a level, which will allow subsequent transplantation are one or more of the following advantages:
Added time for a pathogenic screening of donor samples for contamination and disease. Currently many tests take 2 weeks or longer and, therefore, cannot be performed during the short period of organ viability.
Extended time for improved tissue typing and histocompatibility matching which may improve the quality of organ function and graft survival, and reduce post transplant immunosuppression costs and side effects.
Added time to adequately prepare and/or treat the recipient and the surgical team.
A stored supply of organs for non-emergency cases and potentially creation of a bank of human organs for future transplantation needs.
Added time for other logistical aspects such as transporting and transplanting organs.
Increased post transplantation survival rate and better quality of life.
Banking of organs that would normally be discarded, for use as a temporary graft. For example, fatty livers are usually discarded and not used for transplantation. However, such fatty livers may be used in case of an emergency, for a short period (days or weeks), until the patient's liver recovers or until a better liver is found for this patient. Such fatty livers are typically transplanted as an auxiliary liver, and later removed. By virtue of the present invention, such organs may be tissue-typed and cryogenically preserved for use as a temporary graft when a matching patient is in immediate need of transplantation, but a better suitable organ is not available (or used for another patient for a permanent transplantation).

In another of its aspects, the present invention provides a bank of donated body organs or tissues. The organ bank of the invention is based upon the ability to maintain body organs for prolonged periods of times. The organ bank of the invention accepts body organs and tissues for deposit in the bank from donors and maintains the deposited organs under conditions that maintain the viability of the organs. An individual in need of an organ or tissue transplant can apply to the organ bank in order to determine whether a compatible organ or tissue of the required type has been deposited in the bank. If a suitable organ in the bank is identified, the organ is provided to the individual for transplantation. The organs and tissues deposited in the bank may be bulky biological material.

In a preferred embodiment of the organ bank of the invention, the organ bank offers the following incentive to encourage individuals to donate organs to the organ bank. An individual that undertakes to donate an organ and/or a tissue to the organ bank or to the public, where it is stipulated that the organ and/or tissue may be used for transplantation or any other use at the discretion of the organ bank or another competent authority, such as a medical practitioner or government official, is granted a right to deposit one or more additional organs and/or tissues in the bank to be used only as specified by the donor. The donated organs and/or tissues may be used as a fresh donation or preserved in any manner for future use. The deposited organs and/or tissues will be preserved or used as stipulated by the individual or by a person providing the consent to donate the organs (e.g. the organ donor, a legal guardian, a relative of a deceased donor, etc.). It is to be understood that the organ bank is to include any person or entity capable of lawfully deciding how donated organs and/or tissues are to be handled and transplanted, including any qualified organ procurement agency or any public or governmental authority (for example UNOS in the USA).

For example, an individual may agree to become a donor and to donate an organ, such as a kidney or a liver (or any other organ, whether or not specified in the consent when given), for use at the discretion of the organ bank. To encourage the individual to become a donor, he is granted the right to deposit at least one of his other body organs and tissues, such as his heart or a second kidney, to be used only as specified by the donor. For example, the donor may specify that the additional organs be deposited in the organ bank are to be used only by one or more specified beneficiaries, such as one or more family members. This embodiment of the organ bank of the invention encourages individuals to donate organs and thus increases the number of organs available to individuals in need of such organs. Normally this embodiment relates to consent of a donor to donate organs/tissues upon death. However in some cases, where a donation may be provided from a live donor (e.g. a kidney or significant portion of a liver), the right of depositing additional organs after death may also be granted to a live donor.

The long-term organ banking provided by the organ bank of the invention allows organizations that handle organ donations to approach a family member of a deceased individual that did not sign an organ donor consent form during his lifetime (or any other person having legal authority to donate the deceased individual's organs), and offer the family member the following incentive. If the family member or other person agrees to donate one of the deceased individual's organs or tissue to the organ bank for use at the discretion of the organ bank, or if he agrees that at least one organ be donated for any use that will be decided by a public or governmental organ procurement agency, or any other authority such as UNOS etc., one or more additional organs or tissues of the deceased can be deposited in the bank for use only as specified by the family member or person having legal authority.

The organ bank of the invention may be a community organ bank that is operated under the auspices of a particular community, organization, or group of individuals. An individual that joins a community organ bank undertakes to donate one or more organs or tissues to the organ bank, or to the community, whether this organ will be cryopresereved or used as fresh, and receives as a benefit the right to receive one or more organs or tissues from the bank if and when required. This benefit can optionally be extended to his family members or any other individuals specified by the donor. This community banking concept can be of assistance when an organization handling organ donations approaches a family member of a potential donor when the consent of the family member is required for the donation.

Thus, in one of its aspects, the invention provides a bank of donated body organs or tissues, the bank accepting body organs and tissues for deposit and maintaining the deposited organs under conditions that maintain the viability of the deposited organs and tissues. The deposited body organs may be, for example, bulky biological material. In one embodiment of the organ bank of the invention, the deposited body organs or tissues are maintained under conditions that maintain the viability of the deposited organs or tissues by the method of the invention.

In another of its aspects, the invention provides a method for operating a bank of donated body organs or tissues, the bank accepting body organs and tissues for deposit and maintaining the deposited organs and tissues under conditions that maintain the viability of the deposited organs and tissues, the method comprising:
undertaking to provide an organ or tissue to the bank, said organ or tissue to be used for transplantation or other use at the discretion of the organ bank or a competent authority; and
granting a right to deposit one or more additional organs or tissues in the bank to be used only as specified by the undertaker.
   The undertaker may specify, for example, that one or more of the additional organs be used by one or more specified beneficiaries. One embodiment of this aspect of the invention comprises undertaking to provide an organ or tissue of a deceased individual to the bank, said organ or tissue to be used for transplantation or other use at the discretion of the organ bank; and granting a right to deposit one or more additional organs or tissues of the deceased individual in the bank to be used only as specified by the undertaker.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a chart depicting the freezing of a porcine liver using a Static Freezing System (SFS). The thin line represents the liver's temperature as measured during freezing, and the thick line represents the temperature of the freezing device wall. The arrow points to where the release of latent heat is observed.

FIG. 2 is a chart depicting the freezing of a rat liver using a directional freezing device constructed essentially in accordance with U.S. Pat. No. 5,873,254, being adapted for use with 25 mm diameter glass tubes and having only two thermally conductive blocks. The line represents the liver temperature as measured during freezing. The arrow points to the change in temperature of the liver, where the release of latent heat is evidenced.

FIG. 3 is a chart depicting the freezing of the rat heart using a Static Freezing System (SFS). The thin line and dotted line represent the temperature taken at the intramyocardium and the left atrium (respectively), measured in the rat heart frozen according to one embodiment of the present invention. The thick line represents the temperature of the freezing device wall during the same process. The dashed line represents, as a control, the temperature taken at the left atrium of a rat heart frozen by using constant cooling rate of 0.26° C./rain, from 5° C. to −8° C. (i.e. not in accordance with the present invention).

FIG. 4a is a photograph of a section of a thawed rat liver, after being cryopreserved in accordance with an embodiment of the invention. The arrow points at the central vain. Staining was done with Eosin/Hematoxylin. The Slide shows normal architecture of the parenchyma; endothelial cells present a normal shape.

FIG. 4b is a photograph of a section of a thawed rat liver, after being cryopreserved in accordance with an embodiment of the invention. Immunohistochemistry using α-von Willebrand factor antibody. The arrow points to the central vain. The Slide shows normal architecture of the parenchyma; endothelial cells present a normal shape.

FIG. 5 is a photograph of viable hepatocytes, isolated from a post-thaw rat liver, cryopreserved in accordance with an embodiment of the present invention, and fluorostained with cFDA.

### DETAILED DESCRIPTION OF EXEMPLARY EMBODIMENTS

### Example 1

### Freezing of Liver

Freezing Porcine liver in LSFS

Pigs were anaesthetized (intramuscularly) with 10 mg/kg ketamine hydrochloride and 4 mg/kg xylasine hydrochloride (Vetmarket, Israel). The liver was exposed by a transverse mid-incision. The vena cava caudalis was ligated and a small cut was made. Silicon tubing (Teva medical, Israel. I.D. 3 mm O.D. 4 mm) was inserted via the portal vein and connected to a peristaltic pump. The liver was perfused with Hanks balanced salts solution (Biological industries, Beit Ha'emek, Israel) supplemented with 370 mg/liter Ethylene Diaminetetraacetic Acid (EDTA, Sigma Israel) and 5 U/ml Heparin (Sigma Israel) at 150 ml/min for 5 min. at room temperature in order to flush the blood out of the liver. This was followed by a 5 min. perfusion with freezing solution consisting of University of Wisconsin (UW) solution (Bristol-Myers Squibb Pharmaceutical, Ireland) supplemented with 10% Ethylene Glycol (EG) (Sigma Israel) at 4° C. Flow rate was maintained at 150 ml/min.

After perfusion, the liver (about 25 cm×20 cm×5 cm) with its catheter attached, was excised, and transferred to a Polyethylene bag (37 cm×26.5 cm, with Polyethylene thickness of 0.1 mm). A thermocouple was inserted through the tubing of the portal vain for monitoring the liver temperature. The tubing of the excised liver served also in order to ensure continuity between the perfused organ and the surroundings. The bag was transferred to the Large Static Freezing System (LSFS) and an additional 250 ml of freezing solution (4° C.) was added to the bag. The LSFS was tightened to ensure maximal contact between the bag and the LSFS walls, such that the distance between the device cooling plates was about 5 cm. Total time of cold ischemia was 15±2 min.

During the freezing procedure the LSFS initially cooled the sample to 0° C. for 20 min. Then seeding was initiated by lowering the LSFS blocks' temperatures to −10° C. for 20 min, This was followed by lowering the LSFS blocks' temperatures to −20° C. at a cooling rate of 1° C./min, in order to allow quick removal of latent heat. This temperature was also maintained followed by a cooling rate of 0.2° C./min to a final temperature of at least −40° C. in order to ensure directional growth of the ice crystals inside the liver. This cooling protocol was used, based on several earlier experiments that suggested the proper time for the increased heat removal. The total freezing time was 6 hours.

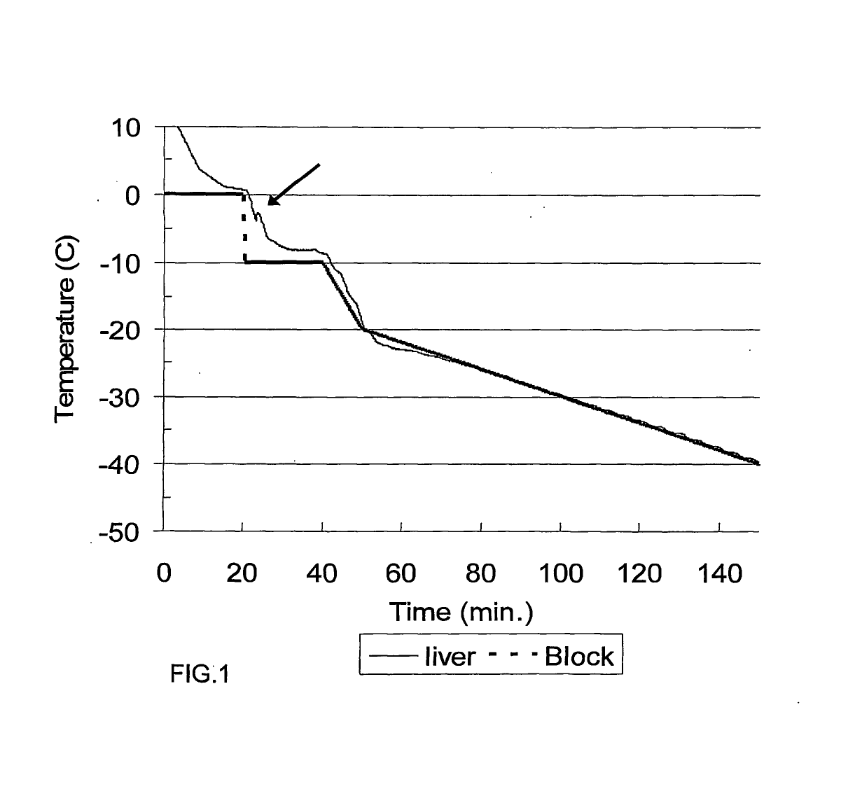

The temperature change recorded during freezing is depicted in FIG. 1, wherein the thin line represents the liver's temperature as measured during freezing, and the thick line represents the temperature of the freezing device wall.

The release of latent heat was observed about 22 minutes into the protocol (see arrow). As can be seen, this heat release was extremely short, and temperature reduction commenced almost immediately. It is believed that this is due to the maintenance of the device at the low temperature of −10° C., a temperature that was maintained until the liver temperature became approximately the same as that of the device. This was apparently facilitated with an additional relatively quick cooling rate of 1° C./min, down to ca.-20° C.

After freezing to −40° C., the liver was thawed as follows: The frozen bag was immersed in a 10 liter bath of 0.9% NaCl in distilled water at 38° C. During the thawing process the liver was rubbed and gently shaken to maximize its surface area in order to quicken the thawing process. Full thawing was achieved after 15-20 min.

Viability Tests

For viability tests, following full thawing, a cannula was re-connected to the portal vain and the freezing solution was washed out with Hanks balanced salts solution for 8 min. at 150 ml/min. Hank's balanced salt solution containing NaHCO₃ (25 mM), CaCl₂ (5 mM), and collagenase (0.2 Wrap was perfused for 8 min. The liver was then shaken gently in a 38° C. bath for 10 min, and then filtrated through a 100 μm mesh. The filtrate was centrifuged 3 times for 4 min at 2000 rpm. The pellet of cells was re-suspended in DMEM supplemented with 10% fetal calf serum, penicillin (100 U/ml), streptomycin (0.1 mg/ml), and insulin (100 nM). Hepatocytes viability was assessed by Trypan-blue exclusion and cFDA fluorostaining using a Hemocytometer.

The results of viability tests for post thaw isolated hepatocytes taken from three different experiments are summarized in Table 1 below:

TABLE 1
Freezing Porcine Liver with Static system (LSFS)

| Final Temp (° C.) | Viability (%) |
|---|---|
| −40 | 75 |
| −40 | 90 |
| −40 | 75 |

Freezing Rat Liver in MTG

Lewis Rats, 220-300 gr., were anaesthetized with Ketamine-xylasin (intra peritoneal). The liver was exposed by a transverse mid incision. The vena cava caudalis was ligated and a small cut was made. 200 tubing was inserted via the portal vein; then the perfusion was started. For collection of bile fluid a polyethylene tube (length: 5 cm, I.D. 0.28 mm, O.D. 0.61 mm, Becton Dickinson, Sparks, Md., USA) was placed in the common bile duct (ductus choledochus). The excised liver was about 5 cm×5 cm and between 1.6 cm and 2 cm thick.

The liver was first perfused with 1 ml of phosphate buffered saline containing 200 units of Heparin, followed by 5 minutes of perfusion using a perfusing solution consisting of Hank's balanced salt solution containing EDTA (0.5 mM). This was followed by a 3 min. perfusion with UW solution supplemented with 10% EG at 4° C. Flow rate was maintained at 23 ml/min. After in situ perfusion the liver was excised and transferred to a 25 mm diameter glass tube that contained the same freezing solution used for perfusion. The tubing of the excised liver ensured continuity between the perfused organ and the surroundings.

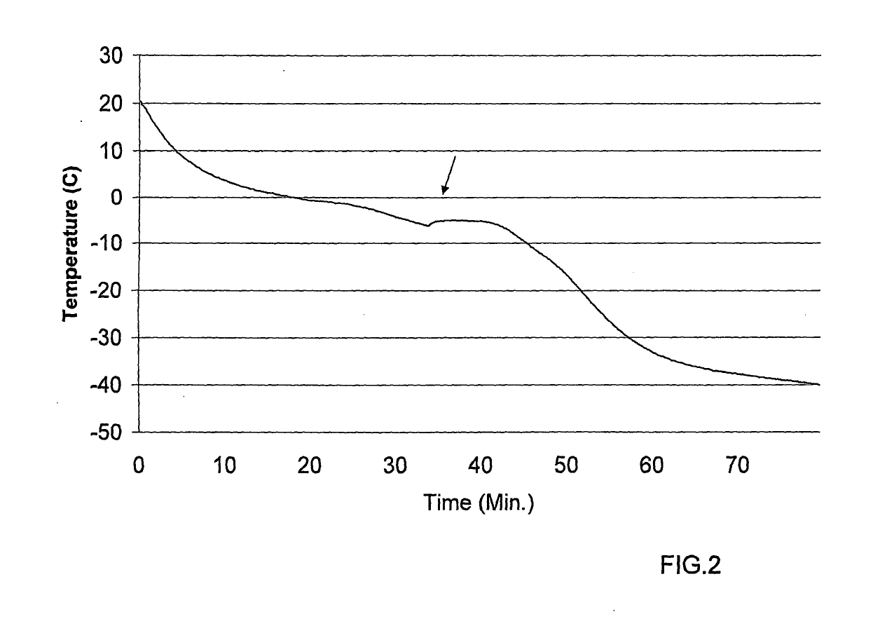

A multi-thermal and multi-velocity freezing protocol was employed using the MTG freezing apparatus (IMT Ltd. Israel). First, seeding was initiated by plunging the tip of the tube into LN for 10 sec. Then the glass tube was inserted into the MTG freezing apparatus. This device is constructed essentially in accordance with U.S. Pat. No. 5,873,254, being adapted to perform the following protocol on 25 mm diameter glass tubes, and having only two thermally conductive blocks. The tube was cooled down to −14° C. at 0.2° C./min., then to −30° C. at 10° C./min. and then to −40° C. at 0.2° C./min, all the time moving at 0.02 mm/sec). The temperature change recorded during freezing is depicted in FIG. 2. When the freezing procedure was completed the frozen glass tube was transferred either to a −80° C. freezer (Thermoforma, U.S.A.), or to a standard −196° C. LN tank, for storage. The livers were stored for 1-21 days.

For the thawing process, the frozen tube was left at room temperature for 5.5 min and then dipped in a 38° C. bath for ca. 30 seconds. Then the contents of the tube (including the frozen liver) are transferred to a turbulent thawing bath which contained phosphate buffered saline at 38° C. for 2.5 min.

Viability Tests

For viability tests, following full thawing, a cannula was re-connected to the portal vain and the freezing solution was washed out for 5 min. Bile production, as indicator of liver function, was calculated per min. per weight of the liver tissue (volume of bile produced per min. divided by the weight of the liver). Results varied from 45-98% compared to fresh liver bile production.

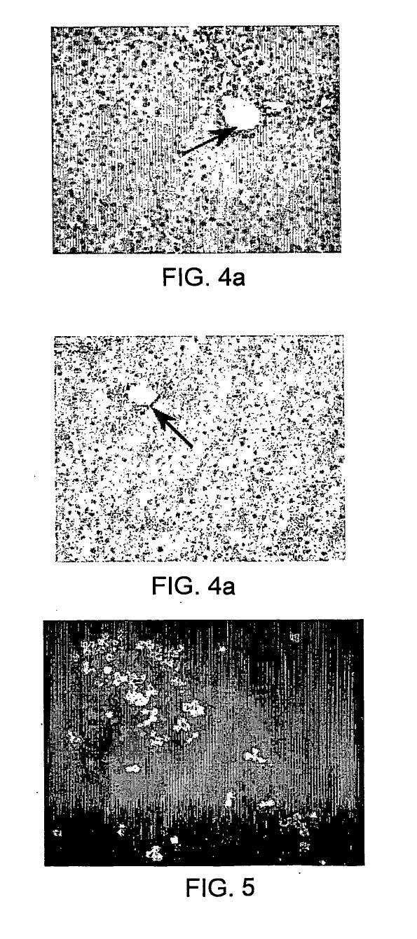

Following washing, biopsies were taken from the rat liver for histology (FIG. 4A, 4B) and Hank's balanced salt solution containing NaHCO₃ (25 mM), CaCl₂ (5 mM), and collagenase (0.2 U/ml) was perfused for 8 min. The liver was then shaken gently in a 37° C. bath for 10 min. Then the liver was filtrated through a 100 μm mesh. The filtrate was centrifuged 3 times for 4 min at 2000 rpm. The pellet of cells was re-suspended in DMEM supplemented with 10% fetal calf serum, penicillin (100 U/ml), streptomycin (0.1 mg/ml) and insulin (100 nM). Hepatocytes viability was assessed by Trypan-blue exclusion and cFDA fluorostaining using a Hemocytometer.

The following tables present the results of the rat liver freezing:

TABLE 2
Freezing rat liver with MTG

| | | Post thaw | | |
|---|---|---|---|---|
| | Final | Viability | Post thaw Bile | |
| | Temperature | (% of total no. | Production | Time of frozen |
| Species | (° C.) | of cells) | (% of fresh) | Storage (Days) |
| Rat | −196 | 85 | 75 | 1 |
| Rat | −196 | 80 | 45 | 1 |
| Rat | −196 | 63 | 60 | 3 |
| Rat | −80 | 92 | 90 | 3 |
| Rat | −80 | 80 | 98 | 7 |
| Rat | −80 | 83 | 65 | 21 |

As can be seen in Table 2, the thawed cells were viable after thawing, displaying up to 92% viability. Bile production after thawing was also substantive, and up to 98% of fresh liver. In fact, the liver remained viable even after 21 days of storage (in frozen state), suggesting that it may remain so practically indefinitely under appropriate storing conditions (e.g. LN storage).

In addition, biopsies of thawed rat liver (after 3-7 days of storage), were fixed in 4% fresh 4° C. paraformaldehyde in PBS. 5 μm sections, from livers that were frozen and thawed as described above, were dehydrated in graded ethanol solutions, cleared in chloroform and embedded in Paraplast (Sigma, Israel). The sections were stained either with Eosin/Hematoxylin (FIG. 4a) or taken for immunohistochemistry using α-von Willebrand factor (vWf, factor VIII) antibody (FIG. 4b). Factor VIII related antigen was detected using Polyclonal anti-human Willebrand factor antibody (Zymed Laboratories, Israel) diluted in 1% normal goat serum in phosphate buffered saline at 1:700 dilution and LSAB2 detection kit (Dako Corp. Santa Barbara, Calif., USA) according to the manufacturer's instructions.

In each of FIGS. 4a and 4b, an arrow points to the central vain. As can be seen, the thawed liver shows normal architecture of the parenchyma and the endothelial cells present a normal shape.

Hepatocytes, were isolated from rat livers (frozen and thawed as detailed above) after 1-21 days of storage, fluorostained with FDA (fluorescein diacetate, Sigma, Israel). Glowing viable hepatocytes are seen in FIG. 5, representing an example from a liver that was stored for 7 days. Similar results were obtained for samples stored up to 21 days (not shown).

### Example 2

### Heart Freezing

Male Sprague Dauley rats (280-320 g) were obtained from Harlan Laboratories (Jerusalem, Israel). The rats were anticoagulated with heparin sodium (500 U/rat, intra peritoneal and 30 minutes later anesthetized with pentobarbital sodium (30 mg/rat, intra peritoneal). Hearts were immediately removed and placed in heparinized ice-cold saline solution. The hearts dimensions were about 2-2.75 cm in length, with a diameter of about 1 cm.

The aorta was cannulated to a Langendorff perfusion apparatus. The pulmonary artery was cut open to provide drainage. Haemodynamic parameters were assayed for each heart during perfusion (before freezing) and reperfusion (after thawing), when the hearts were connected to the Langendorff apparatus, as follows:

A latex balloon-tipped catheter was inserted through an incision in the left atrium and advanced through the mitral valve into the left ventricle and connected to a pressure transducer placed at equivalent height to the heart and a recording system (PowerLab, ADInstruments, Australia). The balloon was inflated and equilibrated to give an end-diastolic pressure of 0 mmHg. Left ventricular systolic and diastolic pressures and time derivatives of pressure were measured during contraction (+dP/dt) and relaxation (−dP/dT). Left ventricular developed pressure (LVDP) was calculated as the difference between the systolic and diastolic pressures.

Hearts were perfused with oxygenated (95% O₂/5% CO₂) Krebs-Henseleit (KH) solution at a constant pressure of 90 cm H₂O with the following composition (mM): KC₁-4.9, CaCl₂ 2.5, NaCl 118, MgSO₄ 1.2, KH₂PO₄ 1.2, NaHCO₃ 25, glucose 11.1. Hearts were subjected to 20 min of perfusion at a constant temperature of 37° C. The hearts were then perfused for 1 min with 10 ml of 4° C. UW solution followed by 3 min perfusion of 10% Ethylene Glycol solution dissolved in UW (UWEG) at 4° C.

The hearts were removed from the Langendorff apparatus and placed in a glass chamber containing UWEG solution at 4° C. and transferred to a Small Static Freezing System (SSFS). For freezing, the following protocol was used: First the SSFS was cooled to 0° C. and remained at that temperature for 15 min, followed by cooling to −5° C. at 0.5° C./min. This was followed by a reduction in the temperature of the SSFS to −10° C. at 1.0° C./min. following adjustment to −20° C. dependent upon the heart's recorded temp on the screen. If the heart's temperature on screen showed a rise (indicating a release of latent heat) then the SSFS temperature set point was lowered to −20° C. until the heart's recorded temp dropped again to the desired temperature.

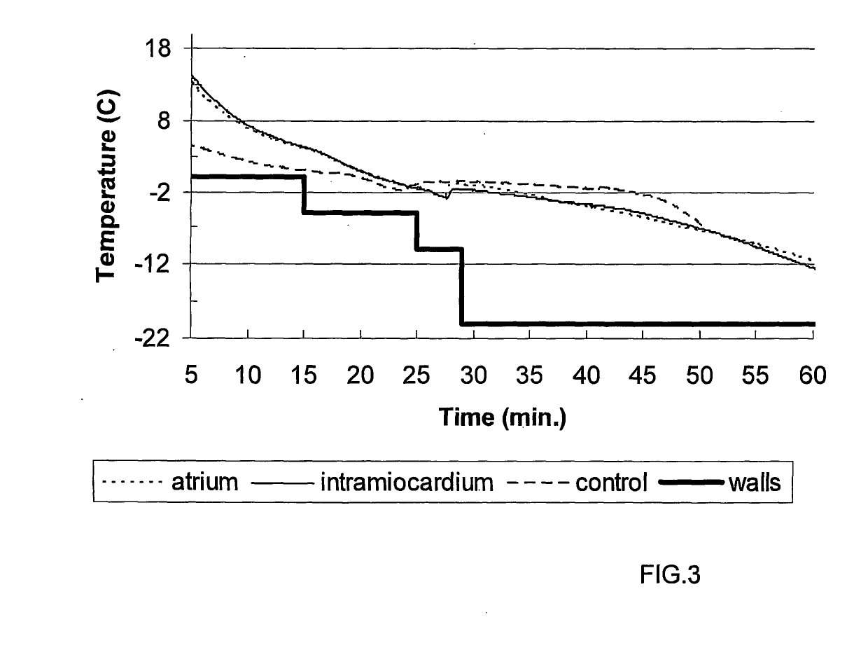

In one heart, in order to confirm the homogeneity of freezing inside the heart, two thermocouples were used for monitoring the heart temperature during freezing: one was inserted through an incision in the left atrium and the other in the intramyocardium (FIG. 3, dotted line and thin line, respectively). As seen in FIG. 3, the temperature profile during freezing was almost identical at both points of measurement. In all other experiments (including the control freezing example), only a single thermocouple was used, measuring temperature only in the left atrium.

After freezing was completed the chamber was removed for thawing from the SSFS to a bath containing 0.9% saline solution at 37° C. for 30 sec. Hearts were removed from the chamber and were re-connected to the Langendorff apparatus for 60 min of reperfusion.

As a control, a heart was prepared as described above, with the exception that the SSFS was set to a constant cooling rate of 0.26° C./min, from 0° C. to −20° C. The temperature of this heart at the left atrium was measured during freezing, and depicted in FIG. 3 as a dashed line.

Surprisingly, during re-perfusion the hearts that were frozen according to the present invention began beating spontaneously.

Viability Tests

1. Left Ventricular Developed Pressure (LVDP)×Heart Rate (HR)

The recovery rate of the heart was derived by multiplication of LVDP by heart rate (HR).

The thawed hearts had a recovery rate (LVDP×HR, measured during reperfusion) of 43.3±120% (assayed for 13 hearts) of the recovery rate measured for the same hearts when they were fresh (during perfusion).

2. Additional Assays

In order to further assay the viability of the hearts frozen and thawed as described above, additional assays were performed, as detailed below, and the results are summarized in Table 3. For this set of tests, hypothermically preserved hearts were used as a control. These hearts were harvested and perfused as described above, and then maintained at 4° C. for 50 minutes. These conditions were chosen in order to approximate donated hearts as they are currently stored and transported before implantation. Reperfusion was the same as for the thawed hearts.

a. MTT

After conclusion of the reperfusion procedures, while the hearts are still beating, left ventricular slices (1 cubic mm) were taken from frozen/thawed hearts for viability and analyzed by 3[4,5-dimethylhiazol-2-yl]-2,5-diphenyltetrazolium bromide (MTT, Sigma Chemical Co.). Tissue viability was expressed as the ratio between the optical density of treated hearts to that of its aerobic controls (8 control hearts perfused with KH for 20 min=100% viability), normalized to dry weight of myocardial tissue.

3. ATP Content and Creatine Phosphate Content

At the end of reperfusion hearts were rapidly frozen with stainless steel blocks precooled in liquid nitrogen. Perchloric acid extracts were prepared from tissue samples. ATP and phosphocreatine levels were assessed by enzymatic assay (Nutt et al., 1991), and expressed as micromoles per gram of dry weight of myocardial tissue (dried at 90° C. for 24 h). The average results are depicted in Table 3 as a percentage from fresh hearts that were assayed immediately after harvest. While it is noted that the results of the frozen-thawed hearts are lower than those of fresh hearts, they are comparable to results of hypothermia hearts.

TABLE 3
Freezing rat hearts with SSFS

Treatment

| | Hypothermia | Cryopreservation |
|---|---|---|
| Test | 0° C. | To −8° C. |
| MTT (% viability of | 69 | 81 |
| control) | n = 4 | n = 4 |
| ATP content (% from | 19.04 | 12.25 |
| fresh) | n = 5 | n = 4 |
| Creatine Phosphate | 34.0 | 22.55 |
| content (% from fresh) | n = 5 | n = 4 |

Those skilled in the art will readily appreciate that various modifications and changes can be applied to the embodiments of the invention as hereinbefore exemplified without departing from its scope defined in and by the appended claims.

1-44. (canceled)

45. A method of freezing bulky biological material, comprising transferring heat out of said material to cool the material and increasing the rate of heat transfer during a time period when the inner portion of said biological material freezes and releases latent heat.

46. The method of claim 45, wherein said heat transfer at least during said time period is at a rate such that heating of biological material that may otherwise occur as a result of the release of the latent heat, is reduced.

47. The method of claim 46, wherein said heating of the biological material or a portion thereof is avoided.

48. The method of claim 45, wherein the rate of heat-transfer before and after said time period is substantially the same.

49. The method of claim 45, wherein said freezing comprises cooling said biological material to a temperature equal or below about −5° C.

50. The method of claim 45, comprising placing the biological material tightly in contact with at least one heat exchanger and controlling the temperature in one or more of the at least one heat exchanger such that a freezing temperature front propagates in said material away from said heat exchanger.

51. The method of claim 50, wherein during said time period the cooling rate is increased to avoid refraction of the freezing temperature front.

52. The method of claim 50, wherein the biological material is placed tightly in contact with two heat exchangers.

53. The method of claim 50, wherein a freezing temperature front propagates in said material away from each of said two heat exchangers.

54. The method of claim 52, wherein at some point during freezing the temperature of said two heat exchangers is essentially the same, and said freezing temperature front propagates from zones of the material adjacent the two heat exchangers to the material's interior.

55. The method of claim 45, wherein the biological material is a solid organ.

56. The method of claim 55, wherein the organ comprises less than 5% DMSO and less than 5% glycerol.

57. A solid organ frozen by the method of claim 55.

58. A viable organ, thawed after freezing by the method of claim 55.

59. The viable organ of claim 57, selected from a human heart, liver or lobe of a liver, or a significant portion of a liver.

60. The viable organ of claims 57, said organ being ex vivo for a period of at least 3 days, 7 days, 12 days or 21 days.

61. The viable organ of claim 57, said organ being a heart, and being ex vivo for a period of at least 5 hours, 12 hours, 24 hours, 3 days, 7 days, 12 days or 21 days.

62. The viable organ of claim 58, selected from a human heart, liver or lobe of a liver, or a significant portion of a liver.

63. The viable organ of claim 58, being ex vivo for a period of at least 3 days, 7 days, 12 days or 21 days.

64. The viable organ of any one of claim 58, being a heart, and being ex vivo for a period of at least 5 hours, 12 hours, 24 hours, 3 days, 7 days, 12 days or 21 days.
